(19) United States
(12) Patent Application Publication
(10) Pub. No.: US 2022/0012008 A1
(43) Pub. Date: Jan. 13, 2022

(54) Apparatus to Visualize System Applications Volume Control

(71) Applicant: Lewis Jamie Tyler, San Jose, CA (US)

(72) Inventor: Lewis Jamie Tyler, San Jose, CA (US)

(21) Appl. No.: 17/369,913

(22) Filed: Jul. 7, 2021

Related U.S. Application Data
(60) Provisional application No. 63/049,141, filed on Jul. 8, 2020.

(51) Int. Cl. G06F 3/16; G06F 3/0481; G06F 3/0484; G06F 13/42

(52) U.S. Cl. CPC G06F 3/165; G06F 3/04817; G06F 2213/0042; G06F 3/162; G06F 13/4282; G06F 3/04847

(57) ABSTRACT

The present invention relates to the field of computer peripheral apparatus and, more particularly, relates to a portable, computer volume control apparatus that incorporate plurality of volume controlling means to control the volume of multiple software applications with ease. Traditionally, controlling the volume of multiple software applications in a computer has been practiced using the volume control software within the computer using the computer's operating system. Hence, the present invention provides a portable computer peripheral volume control apparatus which is useful to adjust the volume of individual applications via physical volume sliders and/or volume knobs.

### CROSS-REFERENCE TO RELATED APPLICATIONS

For purposes of the USPTO extra-statutory requirements, the present application constitutes a nonprovisional patent application of U.S. provisional patent application Ser. No. 63/049,141, entitled “APPARATUS WITH DISPLAY MEANS TO VISUALIZE SYSTEM APPLICATIONS VOLUME CONTROL”, naming LEWIS JAMIE TYLER as inventor, filed Jul. 8, 2020.

### TECHNICAL FIELD OF THE INVENTION

The present invention relates to the field of computer peripheral apparatus and, more particularly, relates to a portable, computer volume control apparatus that incorporate plurality of volume controlling means to control the volume of multiple software applications with ease.

### BACKGROUND OF THE INVENTION

Recent advances in the information technology field and software development has given rise to different new software applications that can be installed into a computer. Similarly, recent developments in computer processors has provided users with computers that have advanced processing abilities and can process multiple software applications at once with ease. Traditionally, controlling the volume of multiple software applications in a computer has been practiced using the volume control software within the computer using the computer's operating system. However, it is not always convenient to control the volume using the computer's operating system when the user is working on multiple software applications at once.

Additionally, another problem of the traditional volume control system software available in the computer's operating system is when then user have to concentrate on a task such as gaming, a slight distraction or deviation to adjust the volume would be problematic in such cases.

Yet another problem, when the user is attending an online meeting using one of the video conferencing application. The notifications from other software applications of the computer would cause disturbance and the user have to hold the video conversation to reduce or mute the volume of other software applications from which the notifications sounds are generated.

These and many other problems have been long identified. Different solutions to the problems have been tried. However there exists no comprehensive solution to all the above problems. None of the prior art inventions and patents, taken either alone or in combination, is effective to overcome the identified defects of developing a portable computer peripheral volume control apparatus.

Therefore, the object of the invention overcomes the limitations and drawbacks from the prior art. To achieve above and other objects, the present invention anticipates a new and entirely different product that resolves the limitations and drawbacks.

Hence, the present invention proposes to resolve the existent technical difficulties to eliminate the shortcomings of prior art. The present invention provides a portable computer peripheral volume control apparatus which is useful to adjust the volume of individual applications via physical volume sliders and/or volume knobs. The proposed apparatus is compatible for the Windows, MacOS and Linux-based operating systems. The said volume control apparatus connects to the user's computer via typical wired connection standards such as USB or any wireless connection standards such as WiFi, Bluetooth, Infrared etc.

The unique feature of the volume control apparatus is the use of embedded miniature displays to indicate which application each volume slider is controlling the volume of Using the volume control apparatus software, users can dynamically assign each volume slider to the application of their choice.

### SUMMARY OF THE INVENTION

Embodiments of the present invention solve the above-mentioned problems by providing a portable computer peripheral volume control apparatus which is useful to adjust the volume of individual applications via physical volume sliders and/or volume knobs. Specifically, the present invention enables users to easily control the volume of individual software applications, without having to open the volume mixer program available in the computer's operating system. The displays means provided in the portable computer peripheral volume control apparatus further enables user's to quickly check which physical volume slider or knob is associated with which software application.

Portable computer peripheral volume control apparatus provided in the present disclosure comprises plurality of volume control means such as sliders or knobs above which plurality of display means are built; where in the said display means are used to visualize the logo of the software application of which the volume has been controlled by the respective sliders or knobs.

This summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following detailed description, figures, and claims.

### BRIEF DESCRIPTION OF THE DRAWINGS

Embodiments of the invention are described in detail below with reference to the attached drawing figures, wherein:

FIG. 1 is one example visualizing the standard portable computer peripheral volume control apparatus.

FIG. 2 is another example visualizing the mini portable computer peripheral volume control apparatus.

FIG. 3 is a visualization of standard portable computer peripheral volume control apparatus connected to a computer.

### DETAILED DESCRIPTION OF THE INVENTION

The following detailed description references the accompanying drawings that illustrate specific embodiments in which the invention can be practiced. The embodiments are intended to describe aspects of the invention in sufficient detail to enable those skilled in the art to practice the invention. Other embodiments can be utilized, and changes can be made without departing from the scope of the invention. The following detailed description is, therefore, not to be taken in a limiting sense. The scope of the invention is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, embodiments of the invention can include a variety of combinations and/or integrations of the embodiments described herein.

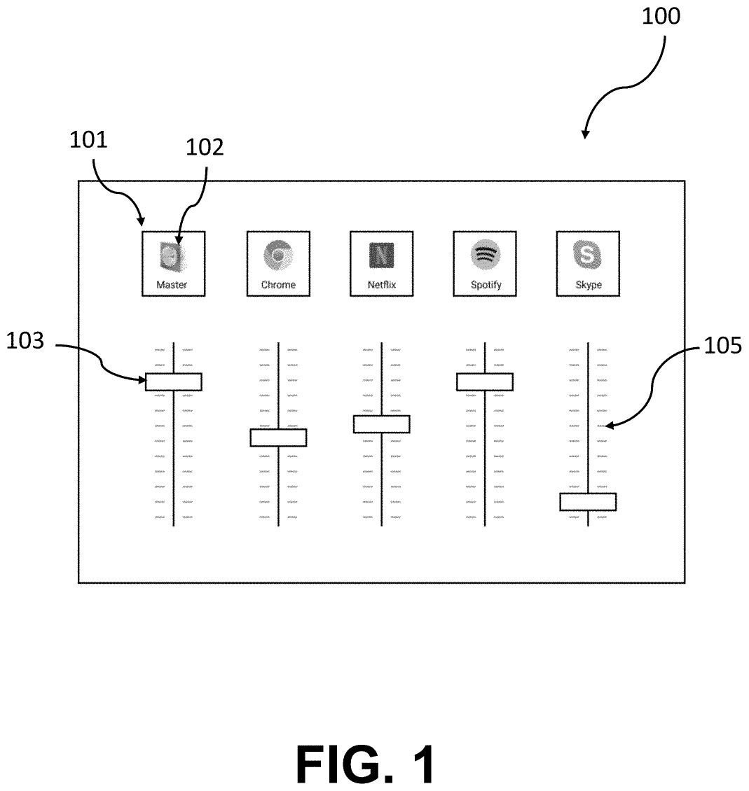

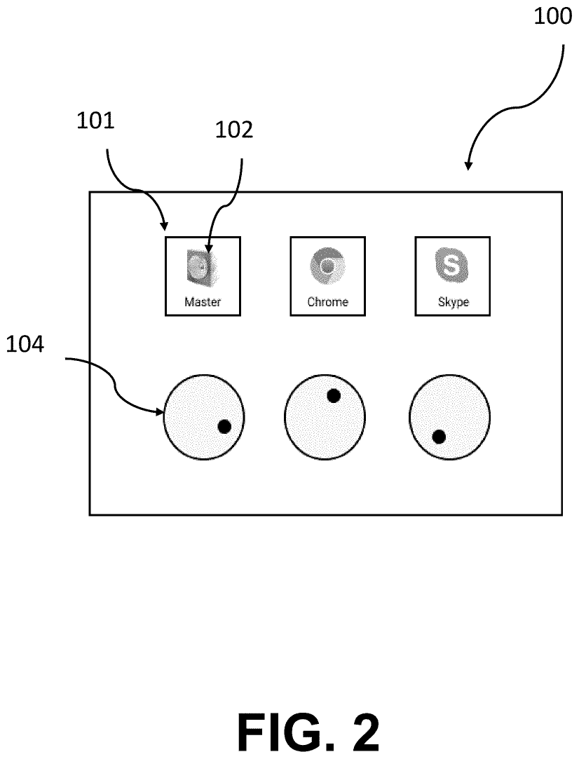

Now referring to the Figures, and specifically FIG. 1 and FIG. 2, embodiments of the present invention comprise a portable computer peripheral volume control apparatus 100. The said volume control apparatus 100 comprises of plurality of display means 101, wherein the said display means 101 are used to visualize the icon 102 of respective software applications which have been assigned to particular volume controlling means such as volume slider 103 as shown in FIG. 1 and volume knob 104 as shown in FIG. 2. For example, as shown in the FIG. 1, the initial display means 101 visualizes the icon 102 of master volume control application of the user's computer that is used to control the overall volume of the user's computer. As visualized in FIG. 1, the volume control means, particularly the volume sliders 103 are built in a way that allows user's to adjust the volume of particular software applications by sliding the said volume sliders 103 upwards or downwards for desired volume setting. Similarly, as visualized in FIG. 2, the volume control means, particularly the volume knobs 104 are built in a way that allows user's to adjust the volume of particular software applications by rotating the said volume knobs 104 clockwise or anticlockwise for desired volume setting. Additionally, the said volume control means are built with volume measurement means, such as volume measurement scale 105 to further visualize the intensity of volume of specific software application that further enables user's to adjust the volume of specific software application to desired volume setting.

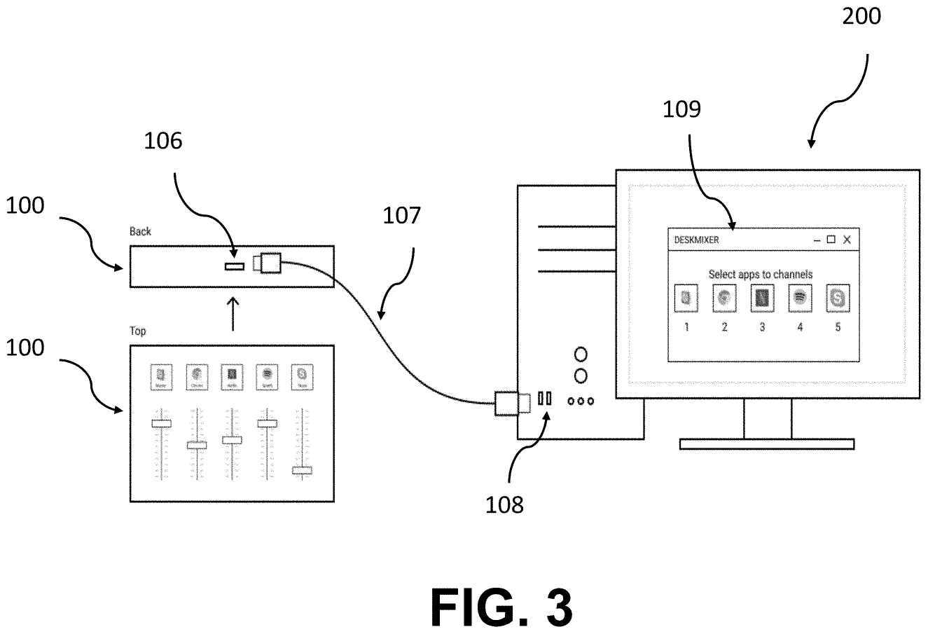

Now, turning to FIG. 3, in a preferred embodiment of the present invention, the portable computer peripheral volume control apparatus 100 is visualized together with the computer means 200 to which the portable computer peripheral volume control apparatus 100 can be connected. Specifically, the said volume control apparatus 100 further comprises of a connection means 106 that enables user's to physically connect the volume control apparatus 100 to any computer means 200. As visualized in FIG. 3, a wired connection can be used to connect the volume control apparatus 100 to any computer means 200. More particularly, the wired connection includes but not limited to a USB connection using a USB cable 107 one end of which is inserted into the USB slot 106 provided on the volume control apparatus 100 and the other the end of which is inserted into the USB slot 107 provided on the computer means 200. Additionally, the said volume control apparatus 100 comprises of a wireless connection means including but not limited to WiFi, Bluetooth, Infrared and/or cellular network.

In the same embodiment of the present invention, FIG. 3 also illustrates the software means 109 that enables users to assign different software applications to desired control channels on the said volume control apparatus 100.

In another embodiment of the present invention, the software means 109 used to assign different software applications on the said volume control apparatus can be developed for different computer means 200 with different operating systems includes but not limited to Windows, MacOS and Linux.

In further embodiment of the present invention, the display means 101 can be developed using different display technologies including but not limited to CRT, LCD, LED and/or OLED.

Although embodiments of the invention have been described with reference to the embodiments illustrated in the attached drawing figures, it is noted that equivalents may be employed and substitutions made herein without departing from the scope of the invention.

Having fully and clearly described the invention so as to enable one having skill in the art to understand and practice the same, the invention claimed is:

1. A portable computer peripheral volume control apparatus comprising:
at least one display means, wherein the said display means is used to visualize an icon of respective software application which have been assigned to particular volume controlling means;
a connection means, wherein the said connection means enables users to connect the volume control apparatus to any computer; and
a software means, wherein the said software means enables users to assign different software applications to desired control channels.

2. The portable computer peripheral volume control apparatus of claim 1, wherein the said display means could be developed using different display technologies that includes CRT, LCD, LED and OLED.

3. The portable computer peripheral volume control apparatus of claim 1, wherein the said volume controlling means could be volume sliders wherein, the said volume sliders are built in a way that allows users to adjust the volume of particular software applications by sliding the said volume sliders upwards or downwards for desired volume setting.

4. The portable computer peripheral volume control apparatus of claim 1, wherein the said volume controlling means could be volume knobs wherein the said volume knobs are built in a way that allows users to adjust the volume of particular software applications by rotating the said volume knobs clockwise or anticlockwise for desired volume setting.

5. The portable computer peripheral volume control apparatus of claim 1, wherein the said volume controlling means are built with volume measurement means, such as volume measurement scale to further visualize the intensity of volume of specific software application that further enables users to adjust the volume of specific software application to desired volume setting.

6. The portable computer peripheral volume control apparatus of claim 1, wherein the said connection means further comprises of a wired connection, wherein the said wired connection includes a USB connection that includes a USB cable one end of which is inserted into the USB slot provided on the volume control apparatus and the other the end of which is inserted into the USB slot provided on the computer.

7. The portable computer peripheral volume control apparatus of claim 1, wherein the said connection further comprises of a wireless connection means, wherein the said wireless connection means includes WiFi, Bluetooth, Infrared and cellular network.

8. The portable computer peripheral volume control apparatus of claim 1, wherein the said software means used to assign different software applications on the said volume control apparatus are developed for different computer means with different operating systems that includes Windows, MacOS and Linux.
